(19) United States
(12) Patent Application Publication
(10) Pub. No.: US 2023/0001910 A1
(43) Pub. Date: Jan. 5, 2023

(54) FLUID VALVE, VALVE ARRANGEMENT AND BRAKING SYSTEM

(71) Applicant: ZF CV Systems Europe BV, Brussels (BE)

(72) Inventors: Steffen Gerlach, Hannover (DE); Karsten-Wilhelm Lüchau, Lachendorf (DE); Armin Sieker, Bielefeld (DE)

(21) Appl. No.: 17/898,135

(22) Filed: Aug. 29, 2022

Related U.S. Application Data
(63) Continuation of application No. PCT/EP2021/055562, filed on Mar. 5, 2021.

(30) Foreign Application Priority Data
Mar. 6, 2020 (DE) 10 2020 106 212.5

(51) Int. Cl. B60T 15/20; F16J 15/3204

(52) U.S. Cl. CPC B60T 15/20; F16J 15/3204

(57) ABSTRACT

The disclosure relates to a fluid valve including a lip seal having a sealing lip between a pressure inlet and a pressure outlet, wherein the position of the sealing lip can be varied to vary a passage cross section. The disclosure further relates to a pneumatic valve arrangement having a park release valve and the fluid valve. The disclosure further relates to a pneumatic braking system including the fluid valve or the pneumatic valve arrangement.

### CROSS REFERENCE TO RELATED APPLICATIONS

This application is a continuation application of international patent application PCT/EP2021/055562, filed Mar. 5, 2021 designating the United States and claiming priority from German application 10 2020 106 212.5, filed Mar. 6, 2020, and the entire content of both applications is incorporated herein by reference.

### TECHNICAL FIELD

The disclosure relates to a fluid valve. The disclosure also relates to a pneumatic valve arrangement and a pneumatic braking system for a vehicle, in particular for a trailer vehicle.

### BACKGROUND

Here, fluid valves are understood to be valves for all flowing media, in particular pneumatic valves, preferably for use in pneumatic braking systems. Pneumatic braking systems in trailer vehicles with park release valves can perform various safety functions. For example, what is referred to as a park/save function can be provided, which is intended to avoid a dangerous situation in conjunction with incorrect operation. When a trailer vehicle is being coupled to a tractor vehicle, the park release valve should be in the parking position. However, even if the park release valve is in its driving position, the as yet uncoupled trailer vehicle is braked since existing spring-loaded brakes are then vented and active. If, in this situation with the park release valve in the driving position, the supply pressure line of the trailer vehicle is now first of all connected to the tractor vehicle by mistake, the spring-loaded brakes are supplied with air and released if the braking system of the trailer vehicle does not have a park/save function. The trailer vehicle can move, even though this is not desired at this time and there is a risk for operators. The park/save function, in contrast, has the effect that the spring-loaded brakes are not yet supplied with air and released under these conditions. On the contrary, the service brake must be actuated at least once. The brake pressure introduced in this case acts as a control pressure for canceling the park/save function. The park/save function and a possible design solution are illustrated in DE 10 2016 005 625 A1, in particular in conjunction with FIGS. 6 to 11.

The park/save function can be integrated into a “park release” valve or can be a component of a valve arrangement via which a park release function is realized. In this regard, FIG. 7 of DE 10 2016 005 625 A1 shows a pneumatic circuit diagram, and FIGS. 8 to 11 show a highly integrated park release valve matching the pneumatic circuit diagram. The park/save function is obtained from the interaction of a control slide 105 with a blocking slide 104 and associated seals and flow channels.

A simpler construction of the individual components is possible by lower integration. The park release valve can be configured as a simple slide valve, while the park/save function can be implemented by a valve provided specifically for this purpose.

### SUMMARY

It is an object of the present disclosure to provide a fluid valve which is suitable as a parking safety valve or for implementing the park/save function. In particular, the fluid valve should be as reliable, smooth-running and maintenance-free as possible.

The object can, for example, be achieved via a fluid valve having a pressure inlet and a pressure outlet. The fluid valve is provided with a lip seal having a sealing lip between the pressure inlet and the pressure outlet, wherein a position of the sealing lip can be varied to vary a passage cross section. According to the disclosure, the sealing lip can assume different positions, thus enabling a passage cross section between the pressure inlet and the pressure outlet to be set. It is preferable if the sealing lip is not moved as a whole. On the contrary, only part of the sealing lip is angled or bent relative to the lip seal. To achieve this, the sealing lip can be produced from a correspondingly elastic material, as can the lip seal as a whole.

The fluid valve is provided, in particular, for pneumatic braking systems in trailer vehicles but can also be used for other applications in connection with flowing media. In contrast to conventional slide valves or seat valves, the frictional forces in the illustrated fluid valve with a switchable lip seal are relatively low.

According to a further concept of the disclosure, provision is made for the sealing lip to rest against a sealing surface in a blocking position and to be at a distance from the sealing surface in a passage position. The passage cross section is defined by the distance and the given geometric conditions.

According to a further concept of the disclosure, provision can be made for the sealing lip to have an internal stress which acts on the sealing lip to reduce the passage cross section. This means that, without being influenced by other components, the sealing lip tends to assume the position with the smallest passage cross section. In particular, the sealing lip then rests against a sealing surface. It is advantageous if the sealing lip extends at an acute angle to the sealing surface and is arranged in a self-retaining manner, that is, when there is a higher pressure at the pressure inlet than at the pressure outlet, the sealing lip is pressed against the sealing surface by the pressure difference and thus holds the abovementioned blocking position.

According to a further concept of the disclosure, provision can be made for the position of the sealing lip to be variable by pressure of a switching element. Via the switching element, the passage cross section is varied indirectly. Here, the pressure of the switching element preferably acts against the internal stress of the sealing lip. The switching element is used to vary the position of the sealing lip and can itself be controlled, for example, by a fluid.

By moving the switching element, it is possible to exert the pressure of the switching element and to switch the sealing lip, thus making it possible optionally to open and close the connection from the pressure inlet to the pressure outlet, or merely to vary the passage cross section. By varying the passage cross section, the sealing lip can thus be switched in a continuously variable manner. Actuation of the sealing lip by the switching element can take place directly or indirectly. For example, an additional component can be provided between the switching element and the sealing lip. The switching element then acts only indirectly on the sealing lip.

According to a further concept of the disclosure, provision can be made for the sealing lip to be supported on the switching element in a blocking position. In the blocking position, the sealing lip then rests, on the one hand, against the sealing surface and, on the other hand, is supported by the switching element, preferably by an edge or collar of the switching element.

According to a further concept of the disclosure, the switching element can rest against the sealing lip, wherein the sealing lip can be acted upon by the switching element to enlarge the passage cross section. In particular, the switching element acts on the sealing lip to a greater extent in a passage position than in the blocking position.

According to a further concept of the disclosure, the lip seal can have a lip holder, on which the sealing lip is held. An angle of the sealing lip relative to the lip holder can be variable by mechanical pressure of the switching element. The change in the angle can also be obtained by deformation of the sealing lip.

According to a further concept of the disclosure, the switching element can be of mushroom-shaped configuration with a stem and a cap. The lip holder can be of cup-shaped configuration with a cup opening and a bottom, wherein the bottom has a bottom opening. The stem can extend into the cup opening as far as the bottom opening. The cap can then rest against the lip seal in the passage position. The lip seal or the cap can be provided with a sealing bead. In this way, the cap seals the cup opening in the passage position of the lip seal.

According to a further concept of the disclosure, the cap can have a circumferential collar which is inclined toward the bottom of the lip holder, wherein the sealing lip extends circumferentially outward from an edge adjacent to the cup opening, and wherein the sealing lip is acted upon by the collar of the cap in the passage position. The collar preferably acts on the sealing lip during the entire actuation of the sealing lip, in particular also in the blocking position.

According to a further concept of the disclosure, the switching element can be acted upon by a return spring in the direction of relief of the sealing lip. The return spring acts against the switching element and must be additionally overcome by pressure at the control port or pressure outlet, as must the internal stress of the sealing lip.

The fluid valve can have a housing.

According to a further concept of the disclosure, provision can be made for the switching element to be movable in the housing counter to the action of the return spring, and for a widened portion of the switching element to rest against a shoulder of the housing with a minimized passage cross section as a result of the action of the return spring. The return spring, the widened portion and the shoulder define an end position of the switching element movable in the housing of the fluid valve.

According to a further concept of the disclosure, the lip holder can be arranged in a fixed manner in the housing. Like the sealing lip, the lip holder is then part of the lip seal. The lip holder is provided in a fixed manner, while the sealing lip is movable or flexible. When the passage cross section is varied, the sealing lip changes its shape, its position and/or its angle relative to the lip holder.

According to a further concept of the disclosure, the housing can have a cylindrical interior space. The switching element can be movable in the axial direction in the interior space. In addition, the lip seal can be held in the interior space. The switching element and the lip seal are preferably matched to the cylindrical shape of the interior space.

According to a further concept of the disclosure, when the passage cross section is closed, the sealing lip can divide the interior space into an outlet volume, which is connected to the pressure outlet, and an inlet volume, which is connected to the pressure inlet. When the passage cross section is not closed, the outlet volume and the inlet volume are connected to one another via the passage cross section.

According to a further concept of the disclosure, a relief volume connected to a relief outlet can be formed between the lip seal and the switching element, wherein the relief volume and the outlet volume are connected to one another via a flow channel in the switching element, at least in a blocking position of the sealing lip. As a result, in the blocking position, a defined pressure is present in the outlet volume, namely as in the relief volume, which is connected to the relief outlet. The pressure at the relief outlet typically corresponds to an ambient pressure of the fluid valve.

According to a further concept of the disclosure, a connection from the relief volume to the flow channel can be closed by a seal between the lip seal and the switching element in the passage position of the sealing lip. The seal separates the relief volume from the flow channel and the outlet volume connected thereto. In this way, the flow channel is securely closed in the passage position.

According to a further concept of the disclosure, a control piston, which can be moved between an initial position and an actuating position, can be present in a housing of the fluid valve, can be moved out of its initial position by pressure at a control port and, in the actuating position, acts on a switching element to actuate the sealing lip. With the movement of the control piston into the actuating position, the sealing lip moves into the passage position. According to a further concept of the disclosure, the control piston can separate a control volume, which is connected to the control port, from an outlet volume, which is connected to the pressure outlet. For this purpose, the control piston is preferably provided with a circumferential seal. The control piston can be moved to reduce the outlet volume by rising pressure in the control volume.

According to a further concept of the disclosure, at least two switching positions can be provided, namely the blocking position and the passage position. Furthermore, at least four ports can be provided, namely the pressure inlet, the pressure outlet, a relief outlet and a control port. Furthermore, a switching element can be movable in the housing. The movable switching element can be provided for the purpose of selectively opening or closing the passage cross section from the pressure inlet to the pressure outlet depending on the pressure at the pressure outlet and at the control port. The switching element can have a holding function, the holding function being configured such that the passage cross section is open when the pressure at the control port is above a first limit value, and remains open even when the pressure at the control port falls below the first limit value again but, at the same time, there is a pressure above a second limit value at the pressure outlet. As a result of the holding function provided, special functions can be performed with the fluid valve, for example as a parking safety valve in a pneumatic braking system. The limit values mentioned are preferably between 1 and 3.5 bar, in particular between 2 and 3 bar. The first and second limit values may be identical, but may also differ.

A pneumatic valve arrangement having a park release valve can have a fluid valve as described herein. In this case, the fluid valve preferably has the function of a parking safety valve. The valve arrangement is preferably provided for a braking system of a vehicle, in particular for a braking system of a trailer vehicle.

According to a further concept of the disclosure, the pressure inlet of the fluid valve can be connected to a supply port, which is at supply pressure, of the valve arrangement, wherein the pressure outlet of the fluid valve is connected to a port of the park release valve, and a control port of the fluid valve is connected to a control port of the valve arrangement. The control port of the valve arrangement can preferably be acted upon by brake pressure from the pneumatic braking system. In a trailer vehicle, the supply port of the valve arrangement receives the supply pressure from a “supply” coupling head, while the brake pressure is fed in via a “brake” coupling head.

The disclosure also relates to a pneumatic braking system for a trailer vehicle, having a fluid valve as disclosed herein or having a valve arrangement as disclosed herein.

### BRIEF DESCRIPTION OF THE DRAWINGS

The invention will now be described with reference to the drawings wherein:

FIG. 1 shows an axial section through a fluid valve in a first switching position, namely in a blocking position;

FIG. 2 shows an axial section corresponding to FIG. 1 in a second switching position, namely in a passage position;

FIG. 3 shows an axial section corresponding to FIG. 1 in a third switching position, namely in a self-holding passage position;

FIG. 4 shows a pneumatic circuit diagram of a valve arrangement having a park release valve, a parking safety valve, a switchable check valve and an emergency brake valve;

FIG. 5 shows a pneumatic circuit diagram, modified as compared to FIG. 4, with the valve arrangement in the same first switching position;

FIG. 6 shows a pneumatic circuit diagram corresponding to FIG. 5 with the valve arrangement in a second switching position;

FIG. 7 shows a pneumatic circuit diagram corresponding to FIG. 5 with the valve arrangement in a third switching position;

FIG. 8 shows an axial section through a parking safety valve in the first switching position according to FIG. 5;

FIG. 9 shows an axial section corresponding to FIG. 8 with the parking safety valve in the second switching position according to FIG. 6; and,

FIG. 10 shows an axial section corresponding to FIG. 8 with the parking safety valve in the third switching position according to FIG. 7.

### DESCRIPTION OF THE PREFERRED EMBODIMENTS

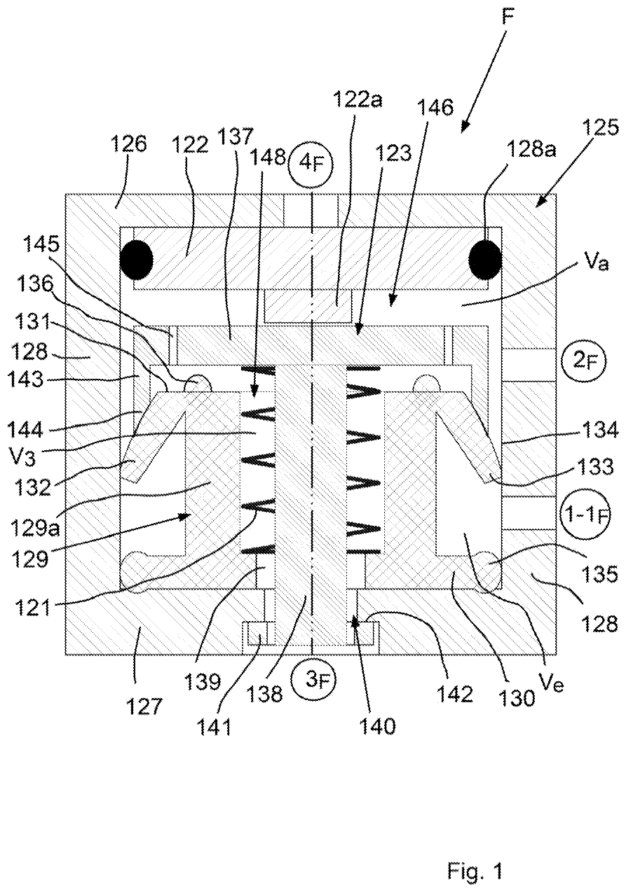

A fluid valve F illustrated in FIGS. 1 to 3 is preferably a 3/2-way valve, can be provided for hydraulic or pneumatic or mixed applications and has at least two switching positions and at least three ports for inlets and outlets. In addition, at least one control port is provided here. The ports or inlets/outlets are provided with numbering customary in fluid engineering and additionally with an index F:

| 1-1_{F} | pressure inlet |
|---|---|
| 2_{F} | pressure outlet |
| 3_{F} | relief outlet |
| 4 | control port |

In order to clarify and distinguish between further reference numerals, the abovementioned numerals in the figures are in each case provided with a circle.

Details of the fluid valve F are explained with reference to the alignment illustrated in the figures. Direction indications used here, such as “top”, “bottom”, “side”, or terms including direction indications relate to the illustration in the figures. It is possible to rotate the fluid valve F relative to this arrangement. The direction indications must then be adapted accordingly.

The fluid valve F has a cylindrical housing 125 with an upper wall 126, a bottom wall 127 and a circumferential side wall 128. The control port 4_{F} is provided in the region of the upper wall 126. A control piston 122 is axially movable in the housing 125 below the upper wall 126 and is provided with a circumferential seal 128a.

A lip seal 129 is arranged on the bottom wall 127 and has a cup-shaped lip holder 129a with a cup opening 148 and with a bottom-side, radially directed bottom collar 130. A collar-like sealing lip 132 extends outward from an upper edge 131 of the cup-shaped lip holder 129a. The sealing lip 132 is directed obliquely downward and, in the first switching position/blocking position shown in FIG. 1, rests with a lower sealing edge 133 against a sealing surface 134 of the housing 125. Here, the sealing surface 134 is provided on the inside of the side wall 128.

The housing 125 has the pressure inlet 1-1_{F} at the side and the pressure outlet 2_{F} axially above it. The sealing surface 134 is located between the pressure inlet 1-1_{F} and the pressure outlet 2_{F}.

The bottom collar 130 is additionally provided radially on the outside with a sealing bead 135, which rests on the inside against the side wall 128 and/or against the bottom wall 127. A circumferential sealing bead 136 is provided on the upper edge 131.

Arranged between the control piston 122 and the lip seal 129 there is a switching element 123, here of T-shaped configuration, which has a cap 137 with a stem 138 underneath it. The stem 138 extends from above into the cup opening 148 and through a bottom opening 139 of the lip holder 129a. At the same time, the stem 138 extends through a bottom-side opening 140 of the housing 125. In this case, the stem 138 is held by a lower widened portion 141 in the opening 140, which has a shoulder 142. The bottom opening 139 and the opening 140 of the housing 125 are arranged coaxially.

A return spring 121 is seated on the stem 138, presses the cap 137 with the stem 138 upward and is supported in the cup-shaped lip holder 129a, with the result that the widened portion 141 rests against the shoulder 142 from below, see the first switching position/blocking position in FIG. 1. In this case, the widened portion 141 does not completely close the opening 140, and therefore a pressure equalization via the opening 140 and the adjoining relief outlet 3_{F} remains possible.

The cap 137 of the switching element 123 is provided radially on the outside with a downwardly directed collar 143, the lower edge 144 of which supports the sealing lip 132 on the outside or rests against it without pressure. In FIG. 1, the sealing bead 136 is at a distance from the cap 137. Flow channels 145 are located in the cap 137, thus enabling air to be admitted to a space between the sealing bead 136 and the collar 143.

An interior space 146 of the housing 125 is at least divided into an inlet volume Vₑ connected to the pressure inlet 1-1_{F}, an outlet volume Vₐ connected to the pressure outlet 2_{F}, a relief volume V₃ connected, in particular, via the bottom opening 139 and the opening 140 to the relief outlet 3_{F}, and a control volume V_{S} connected to the control port 4_{F}.

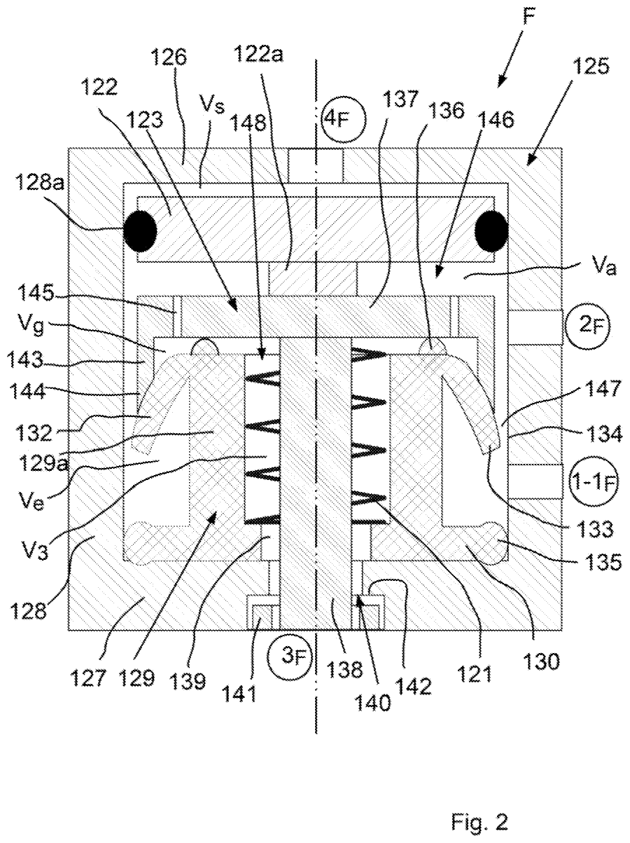

FIG. 2 shows the fluid valve F in a second switching position, which at the same time is a forced passage position. Via the control port 4_{F}, control pressure acts in the control volume V_{S} and on the control piston 122, with the result that the control piston 122, with a lower extension 122a which is narrower in the radial direction than the control piston 122, acts on the switching element 123 by pressure on the cap 137 and presses it downward, counter to the resistance of the return spring 121. In the process, the collar 143 presses the sealing lip 132 downward into the passage position shown.

The lower sealing edge 133 has come away from the sealing surface 134 and a passage 147 has been created from the pressure inlet 1-1_{F} to the pressure outlet 2_{F}, resulting in a pressure equalization. At the same time, the cap 137 comes into contact with the sealing bead 136. A pressure equalization within a trapped volume V_{g} formed thereby between the sealing bead 136, the collar 143 and the sealing lip 132 radially outside the sealing bead 136 is possible through the flow channels 145.

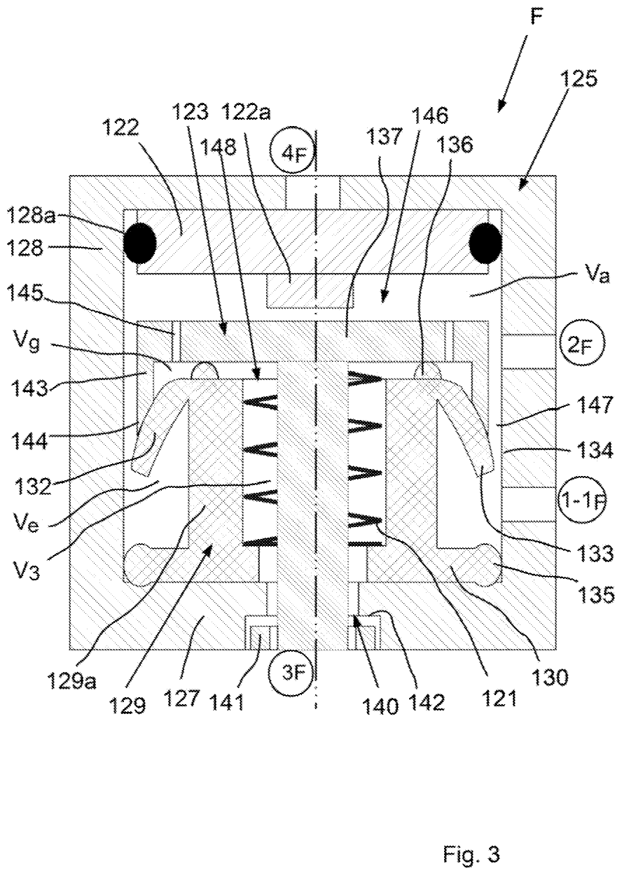

Starting from the second switching position in FIG. 2, control pressure is then no longer fed in via the control port 4_{F}. This results in the third switching position shown in FIG. 3. This too is a passage position, but without the control piston 122 acting on the switching element 123. As a result of the pressure prevailing in the outlet volume Vₐ, a force also acts on the switching element 123 in the downward direction, with the result that the sealing lip 132 remains in the passage position and the passage 147 is kept open. In addition, the control piston 122 is pressed upward in the direction of the control port 4_{F} and into the position as illustrated in FIGS. 1 and 3, that is, until it rests against the upper wall 126.

In summary, the following states are shown in FIGS. 1 to 3:

FIG. 1 shows the blocking position of the sealing lip 132 and the switching element 123 and an initial position of the control piston 122, without pressure at the control port 4_{F}:

FIG. 2 shows the forced passage position of the sealing lip 132 and the switching element 123 and an actuation position of the control piston 122 in the case of pressure at the control port 4_{F} above a first limit value;

FIG. 3 shows the self-holding passage position of the sealing lip 132 and the switching element 123 and the initial position of the control piston 122 after a pressure decrease at the control port 4_{F}, in the case of pressure in the outlet volume Vₐ above a second limit value.

The first limit value for the pressure at the control port 4_{F} and the second limit value for the pressure in the outlet volume Vₐ are preferably between 1 and 3.5 bar, in particular between 2 and 3 bar. The force of the return spring 121 and the two limit values mentioned are matched to one another.

In contrast to FIG. 1, the sealing lip 132 does not necessarily have to occupy a blocking position. It is also possible for the sealing lip 132 to be moved by the switching element 123 only to achieve passages 147 of different sizes and/or for continuous adjustment of the passage 147. At least one passage position with a small passage and one passage position with a passage which is larger in comparison are then obtained.

Likewise as a departure from the illustration in the figures, the fluid valve F need not necessarily have the control piston 122 and the control port 4_{F}. Instead, there may also be some other type of control or actuation of the switching element 123, such as electromagnetic actuation as in the case of a solenoid valve or a mechanical pushbutton. The important elements are lip seal 129, switching element 123, pressure inlet 1-1_{F}, pressure outlet 2_{F}, relief outlet 3_{F} and preferably the return spring 121 or some other return element and any type of actuation of the switching element 123.

The fluid valve F can be used for all applications in connection with flowing media. In contrast to conventional slide valves or seat valves, the frictional forces in the illustrated fluid valve with a switchable lip seal are relatively low.

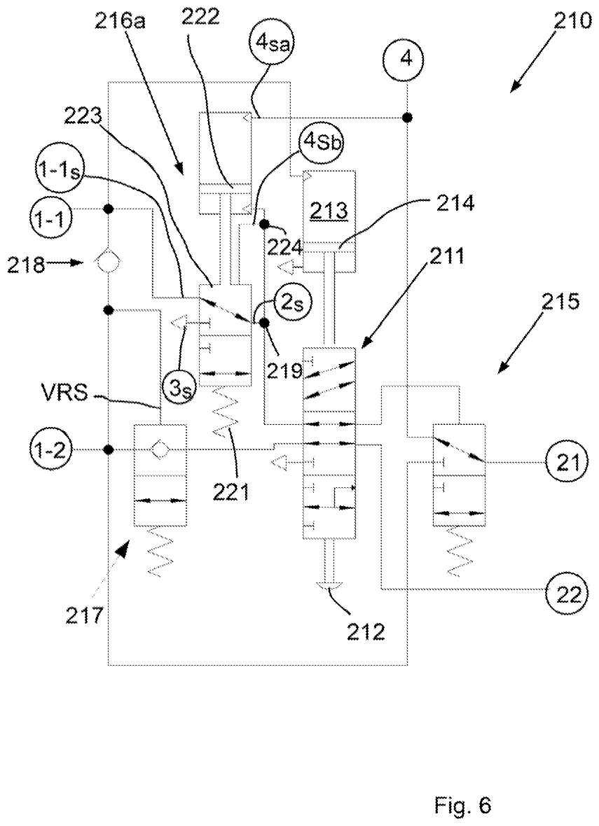

The illustrated fluid valve can be used, for example, in a pneumatic braking system for a trailer vehicle of the kind illustrated, for example, in DE 10 2016 005 625 A1, FIG. 6. At the bottom right of the figure, a valve arrangement with the function of a park release valve is illustrated, see reference number 23 there. A parking safety valve is also a part of the valve arrangement, see there above the component with the reference number 109. An emergency brake valve is provided as an external component, that is, outside the valve arrangement, see reference number 37 there.

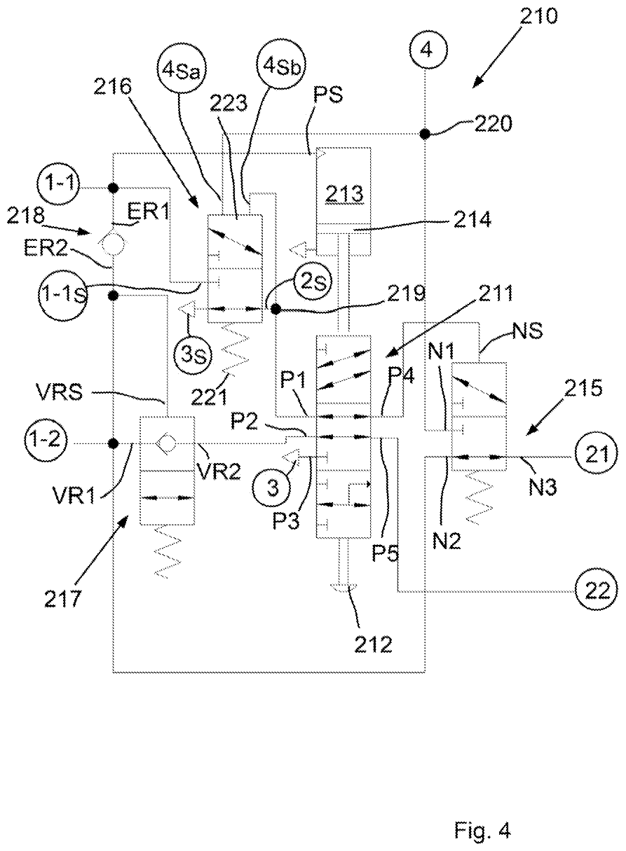

Without this being intended to result in a restriction of the disclosure, a fluid valve according to the disclosure is illustrated by way of example in FIGS. 4 to 10 in the context of a specific embodiment of a parking safety valve and its functioning within a valve arrangement such as, for example, the valve arrangement disclosed in DE 10 2016 005 625 A1. The latter can also be described as a valve arrangement with the function of a park release valve and additional functions.

As for the illustration of the fluid valve F, the following also applies below: Direction indications used here for clarification, such as “top”, “bottom”, “side”, or terms including direction indications, such as “bottom opening”, “bottom collar”, et cetera, relate to the illustration in the figures. It is possible to install the parking safety valve 216, 216a in a position rotated relative to this. The direction indications must then be adapted accordingly.

A valve arrangement 210 has a park release valve 211 in the form of a 5/3-way valve with operating unit 212 and ports P1, P2, P3, P4, P5. Moreover, the park release valve 211 is provided with a control port PS, via which a control piston 214 arranged in a control volume 213 can be acted upon in order to adjust the park release valve 211.

A further component of the valve arrangement 210 is an emergency brake valve 215 with ports N1, N2, N3 and control port NS, in the form of a 3/2-way valve.

A further component of the valve arrangement 210 is a parking safety valve 216 with ports 1-1_{S}, 2_{S}, 3_{S} and control inlet 4_{Sa} and 4_{Sb}, in the form of a 3/2-way valve.

A further component of the valve arrangement 210 is an adjustable check valve 217 with ports VR1, VR2 and a control port VRS.

Finally, another component of the valve arrangement 210 is a simple check valve 218 with ports ER1 and ER2.

The valve arrangement 210 is integrated into the pneumatic braking system of a trailer vehicle (not shown specifically) in a manner similar to that illustrated in DE 10 2016 005 625 A1. In pneumatic circuit diagrams, inlets and outlets of pneumatic elements are usually provided with standardized designations. This is also the case in the figures. The corresponding ports of the valve arrangement 210 are

| | |
|---|---|
| 1-1 | supply port, |
| 1-2 | reservoir port, |
| 21 | brake pressure port, |
| 22 | spring-loaded accumulator port, |
| 3 | vent port, |
| 4 | control port |

and are each provided with a circle for clarity.

In addition, in the figures, the ports of the parking safety valve 216 are also numbered in accordance with the standardized designations, namely

| | |
|---|---|
| port 1-1_{S} | pressure inlet, |
| port 2_{S} | pressure outlet, |
| port 3_{S} | relief outlet, |
| port 4_{Sa} | control port, |
| port 4_{Sb} | control port. |

For clarity, these port designations are also each provided with a circle.

The connection of the valves 211, 215, 216, 217 and 218 to the ports can be seen in FIG. 4. The connection of the parking safety valve 16 to the other valves 211, 215, 217, 218 is of particular importance.

Port 1-1_{S} is connected as a pressure inlet to the supply port 1-1. Port 2_{S}, as a pressure outlet, is connected via a node 219 to control port 4_{Sb}, on the one hand, and to port P1 of the park release valve 211, on the other hand. In the illustrated driving position of the park release valve 211, there is a connection from port P1 to port P4 and from there to the control port NS of the emergency brake valve 215.

Control port 4_{Sa} is connected via a node 220 to the control port 4 of the valve arrangement 210 and to port N1 of the emergency brake valve 215. In the driving position shown in FIG. 4, there is sufficient pressure at the supply port 1-1 and at the reservoir port 1-2, with the result that there is pressure in the control volume 213 and the park release valve 211 cannot drop into a release position. In addition, the control port VRS is supplied with pressure, with the result that the adjustable check valve 217 is in the non-return position shown.

The parking safety valve 216 in FIG. 4 has a holding function. A blocking position is shown. This means that there is no passage from the pressure inlet 1-1_{S} to the pressure outlet 2_{S}. The parking safety valve 216 switches into the passage position (not shown) when, via control port 4 and the control port 4_{Sa} connected thereto, a pressure above a limit value is fed in, overcoming the action of a return spring 221. Subsequently, the pressure inlet 1-1_{S} is connected to the pressure outlet 2_{S}. As long as there is sufficient pressure above a second limit value at the pressure inlet 1-1_{S} connected to the supply port 1-1 and thus also at the pressure outlet 2_{S}, the holding function is active and the parking safety valve 216 remains in the passage position.

In the driving position shown, the parking safety valve 216 is used to supply port P1 of the park release valve 211 with supply pressure via the supply port 1-1 only when, after a pressure loss, for example due to the uncoupling of a trailer vehicle from the tractor vehicle, brake pressure has been fed in at least once via control port 4.

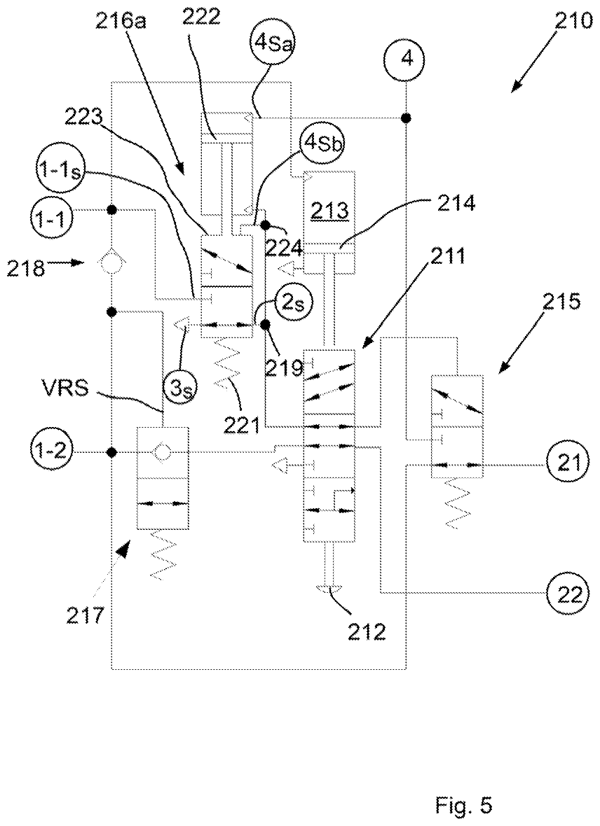

FIGS. 5 to 7 show the pneumatic circuit diagram of FIG. 4 with a slightly modified parking safety valve 216a, namely with a control piston 222 and in three different switching positions. Pressure at control port 4_{Sa} acts directly on the control piston 222.

In the first switching position according to FIG. 5, the parking safety valve 216a is in the blocking position, like the parking safety valve 216 in FIG. 4. There is no pressure at control port 4_{Sa}, nor at the further control port 4_{Sb}. It is assumed that supply pressure is present at the supply port 1-1, as well as at the pressure inlet 1-1_{S}, for example in the case where there is a connection from the trailer vehicle to the tractor vehicle and an adequate supply pressure in the tractor vehicle. The park release valve 211 is in the driving position. The emergency brake valve 215 does not receive any control pressure.

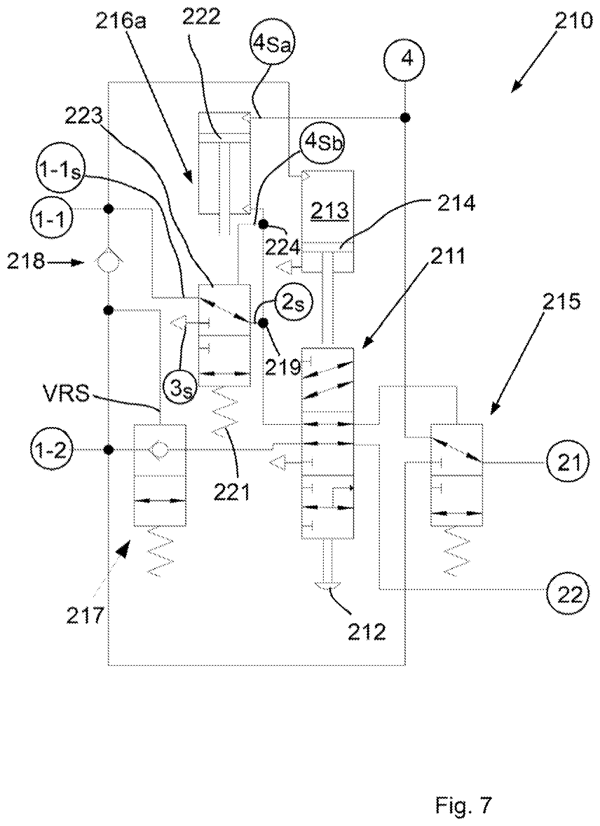

When there is sufficient pressure at control port 4_{Sa}, the control piston 222 switches a switching element 223 into the passage position according to FIG. 6 against the pressure of the return spring 221. Since the second control port 4_{Sb} is connected to the pressure outlet 2_{S} via the node 219 and a further node 224, the switching element 223 remains in the passage position, even if pressure is no longer present at control port 4_{Sa}, see FIG. 7. In addition, the control piston 222 is there moved back into the position according to FIG. 5 by the pressure at control port 4_{Sb}.

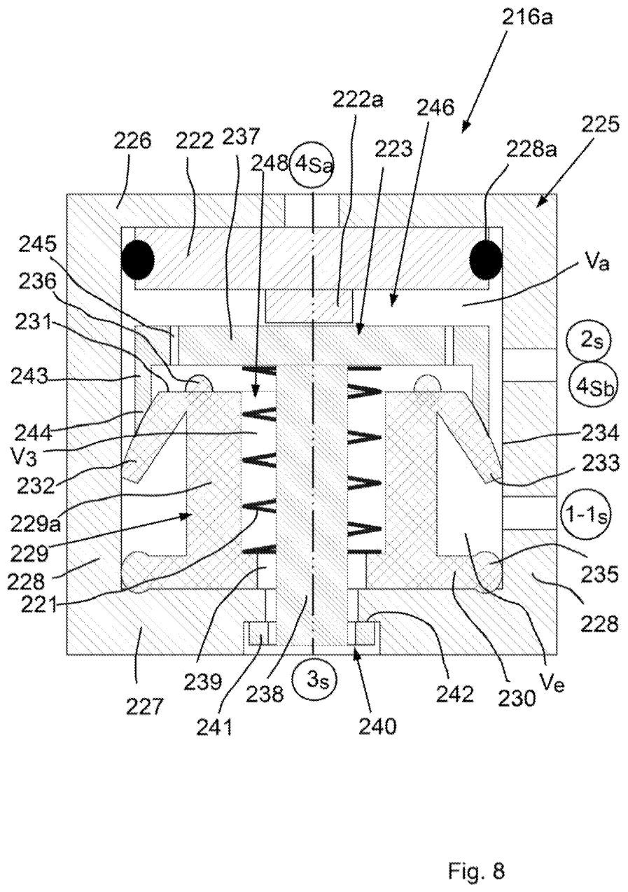

An embodiment of the parking safety valve 216a is illustrated in axial section in FIGS. 8 to 10, matching FIGS. 5 to 7 and analogous to FIGS. 1 to 3. The parking safety valve 216a corresponds in configuration and function to the fluid valve F, apart from control port 4_{Sb}. All the features and functions mentioned in connection with the fluid valve F can also be provided for the parking safety valve.

In a cylindrical housing 225 with an upper wall 226, a bottom wall 227 and a circumferential side wall 228, the control piston 222 can be moved axially in an upper region below control port 4_{Sa} and is provided with a circumferential seal 228a.

A lip seal 229 is arranged on the bottom wall 227 and has a cup-shaped lip holder 229a with a cup opening 248 and a bottom-side, radially directed bottom collar 230. A collar-like sealing lip 232 extends outward from an upper edge 231 of the lip holder 229a. The sealing lip 232 is directed obliquely downward and, in the blocking position shown in FIG. 8, which is simultaneously the first switching position, rests with a lower sealing edge 233 against a sealing surface 234 of the housing 225.

The bottom collar 230 is additionally provided radially on the outside with a sealing bead 235, which rests on the inside against the side wall 228 and/or against the bottom wall 227. A circumferential sealing bead 236 is provided on the upper edge 231.

The housing 225 has the pressure inlet 1-1_{S} at the side and the pressure outlet 2_{S}. The sealing surface 234 is located between the pressure inlet 1-1_{S} and the pressure outlet 2_{S}.

Arranged between the control piston 222 and the lip seal 229 there is the switching element 223, here of T-shaped configuration, which has a cap 237 with a stem 238 underneath it. The stem 238 extends from above into the cup opening 248 and through a bottom opening 239 of the lip holder 229a and a bottom-side opening 240 of the housing 225 and is held by a lower widened portion 241 in the opening 240, which has a shoulder 242.

The return spring 221 is seated on the stem 238, presses the cap 237 with the stem 238 upward and is supported in the cup-shaped lip holder 229a, with the result that the widened portion 241 rests against the shoulder 242, see the blocking position in FIG. 8. In this case, the widened portion 241 does not completely close the opening 240, and therefore a pressure equalization via the opening 240 remains possible.

The cap 237 is provided radially on the outside with a downwardly directed collar 243, the lower edge 244 of which supports the sealing lip 232 on the outside or rests against it without pressure. The sealing bead 236 is at a distance from the cap 237. Flow channels 245 are located in the cap 237, thus enabling air to be admitted to a space between the sealing bead 236 and the collar 243.

An interior space 246 of the housing 225 is at least divided into an inlet volume Vₑ connected to the pressure inlet 1-1_{S}, an outlet volume Vₐ connected to the pressure outlet 2_{S}, a relief volume V₃ connected via the bottom opening 239 and the opening 240 to the relief outlet 3_{S}, and a control volume V_{S} connected to control port 4_{Sa}. The relief outlet 3_{S} has, in particular, the function of a vent.

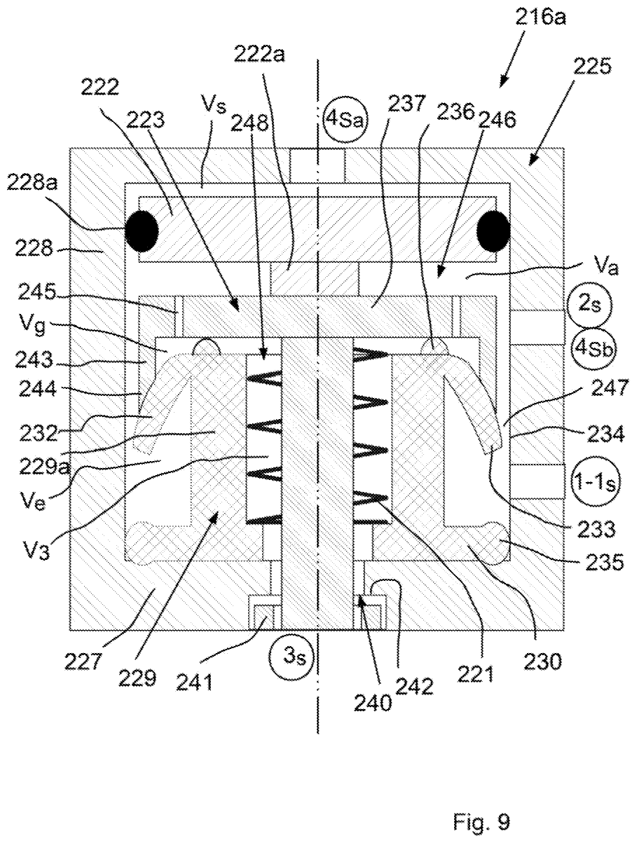

FIG. 9 shows the parking safety valve 216a in a second switching position, as also illustrated in FIG. 6. Via control port 4_{Sa}, control pressure acts in the control volume V_{S} and on the control piston 222, with the result that the latter, with a lower extension 222a, acts on the switching element 223 by pressure on the cap 237 and presses it downward, counter to the resistance of the return spring 221. In the process, the collar 243 presses the sealing lip 232 downward into a passage position. The lower sealing edge 233 comes away from the sealing surface 234 and a passage 247 is created from the pressure inlet 1-1_{S} to the pressure outlet 2_{S}, and therefore the same pressure is present in each case. At the same time, the cap 237 comes into contact with the sealing bead 236. A pressure equalization within a trapped volume V_{g} formed thereby between the sealing bead 236, the collar 243 and the sealing lip 232 radially outside the sealing bead 236 is possible through the flow channels 245.

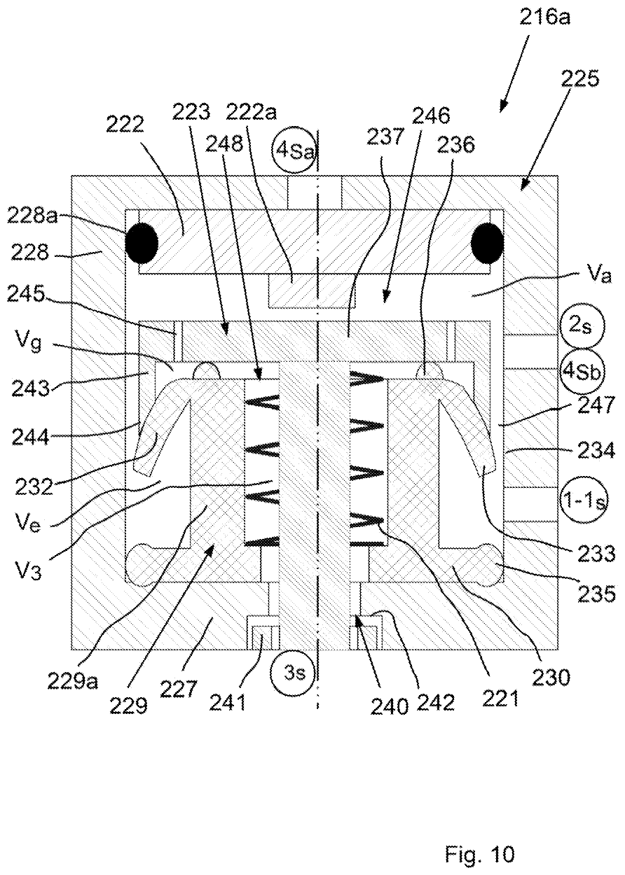

Starting from the switching position in FIG. 9, control pressure is then no longer fed in via control port 4_{Sa}. This results in the third switching position shown in FIG. 10. As a result of the pressure prevailing in the outlet volume Vₐ, a force also acts on the switching element 223 in the downward direction, with the result that the sealing lip 232 remains in the passage position and the passage 247 is kept open. In addition, the control piston 222 is pressed upward in the direction of control port 4_{Sa} and into a position as illustrated in FIG. 8.

In summary, the following states are shown in FIGS. 8 to 10:

FIG. 8 shows the blocking position of the sealing lip 232 and the switching element 223 and the initial position of the control piston 222;

FIG. 9 shows the passage position of the sealing lip 232 and the switching element 223 and the actuation position of the control piston 222 when there is pressure at control port 4_{Sa}:

FIG. 10 shows the passage position of the sealing lip 232 and the switching element 223 and the initial position of the control piston 222 after a pressure decrease at control port 4_{Sa}, but sufficient pressure in the outlet volume Vₐ.

The pressure at control port 4_{Sa} in FIG. 9 and the adequate pressure in the outlet volume Vₐ are preferably between 1 and 3.5 bar, in particular between 2 and 3 bar.

The parking safety valve 216, 216a explained via the embodiments, which is provided, in particular, for pneumatic braking systems in trailer vehicles, can also be used—as described—for other applications in connection with flowing media. In contrast to conventional slide valves or seat valves, the frictional forces in the illustrated parking safety valve with a switchable lip seal are relatively low.

It is understood that the foregoing description is that of the preferred embodiments of the invention and that various changes and modifications may be made thereto without departing from the spirit and scope of the invention as defined in the appended claims.

LIST OF REFERENCE SIGNS
Ports of the valve arrangement

| | |
|---|---|
| 1-1 | supply port |
| 1-2 | reservoir port |
| 21 | brake pressure port |
| 22 | spring-loaded accumulator port |
| 3 | vent |
| 4 | control port |

Ports of the fluid valve

| | |
|---|---|
| 1-1_{F} | pressure inlet |
| 2_{F} | pressure outlet |
| 3_{F} | relief outlet |
| 4 | control port |

Ports of the parking safety valve

| | |
|---|---|
| 1-1_{S} | pressure inlet |
| 2_{S} | pressure outlet |
| 3_{S} | relief outlet |
| 4_{Sa} | control port |
| 4_{Sb} | control port |
| 121 | return spring |
| 122 | control piston |
| 122a | extension |
| 123 | switching element |
| 125 | housing |
| 126 | upper wall |
| 127 | bottom wall |
| 128 | side wall |
| 128a | circumferential seal |
| 129 | lip seal |
| 129a | lip holder |
| 130 | bottom collar |
| 131 | upper edge |
| 132 | sealing lip |
| 133 | lower edge |
| 134 | sealing surface |
| 135 | sealing bead |
| 136 | sealing bead |
| 137 | cap |
| 138 | stem |
| 139 | bottom opening (lip seal) |
| 140 | opening (housing) |
| 141 | widened portion |
| 142 | shoulder |
| 143 | collar |
| 144 | lower edge |
| 145 | flow channels |
| 146 | interior space |
| 147 | passage |
| 148 | cup opening |
| 210 | valve arrangement |
| 211 | park release valve |
| 212 | operating unit |
| 213 | control volume |
| 214 | control piston |
| 215 | emergency brake valve |
| 216 | parking safety valve |
| 216a | parking safety valve |
| 217 | adjustable check valve |
| 218 | simple check valve |
| 219 | node |
| 220 | node |
| 221 | return spring |
| 222 | control piston |
| 222a | extension |
| 223 | switching element |
| 224 | node |
| 225 | housing |
| 226 | upper wall |
| 227 | bottom wall |
| 228 | side wall |
| 228a | circumferential seal |
| 229 | lip seal |
| 229a | lip holder |
| 230 | bottom collar |
| 231 | upper edge |
| 232 | sealing lip |
| 233 | lower sealing edge |
| 234 | sealing surface |
| 235 | sealing bead |
| 236 | sealing bead |
| 237 | cap |
| 238 | stem |
| 239 | bottom opening (lip seal) |
| 240 | opening (housing) |
| 241 | widened portion |
| 242 | shoulder |
| 243 | collar |
| 244 | lower edge |
| 245 | flow channels |
| 246 | interior space |
| 247 | passage |
| 248 | cup opening |
| ER1 | port |
| ER2 | port |
| F | fluid valve |
| N1 | port |
| N2 | port |
| N3 | port |
| NS | control port |
| P1 | port |
| P2 | port |
| P3 | port |
| P4 | port |
| P5 | port |
| PS | control port |
| Vₐ | outlet volume |
| Vₑ | inlet volume |
| V_{g} | trapped volume |
| V_{S} | control volume |
| V₃ | relief volume |
| VR1 | port |
| VR2 | port |
| VRS | control port |

What is claimed is:

1. A fluid valve comprising:
a pressure inlet;
a pressure outlet; and,
a lip seal having a sealing lip between said pressure inlet and said pressure outlet, wherein said sealing lip has a position which is variable so as to vary a passage cross section.

2. The fluid valve of claim 1, wherein said sealing lip rests against a sealing surface in a blocking position and thus closes said passage cross section; and, said sealing lip is at a distance from said sealing surface in a passage position.

3. The fluid valve of claim 1, wherein said sealing lip has an internal stress which acts on said sealing lip to reduce said passage cross section.

4. The fluid valve of claim 1 further comprising a switching element; and, wherein the position of said sealing lip can be varied by pressure of said switching element.

5. The fluid valve of claim 4, wherein said sealing lip is supported on said switching element in a blocking position.

6. The fluid valve of claim 4, wherein said switching element rests against said sealing lip; and, said switching element is configured to act on said sealing lip to enlarge the passage cross section.

7. The fluid valve of claim 4, wherein said lip seal has a lip holder on which said sealing lip is held; and, said sealing lip defines an angle relative to said lip holder; and, said angle can be varied by pressure of said switching element.

8. The fluid valve of claim 7, wherein said switching element is mushroom-shaped with a stem and a cap; said lip holder is cup-shaped with a cup opening and a base; said base defines a base opening and said stem extends into said cup opening as far as said base opening; and, said cap rests against the lip seal in a passage position.

9. The fluid valve of claim 8, wherein said cap has a circumferential collar inclined toward said base of said lip holder; said sealing lip extends circumferentially outward from an edge adjacent to said cup opening; and, said sealing lip is acted upon by said collar in a passage position.

10. The fluid valve of claim 4 further comprising a return spring configured to act on said switching element in a direction of relief of said sealing lip.

11. The fluid valve of claim 10 further comprising:
a housing having a shoulder;
said switching element being configured to be moved in said housing counter to the action of said return spring; and,
said switching element having a widened portion which rests against said shoulder of said housing with a minimized passage cross section as a result of the action of the return spring.

12. The fluid valve of claim 1 further comprising:
a housing;
said lip seal having a lip holder;
said sealing lip being held on said lip holder; and,
said lip holder being arranged in a fixed manner in said housing.

13. The fluid valve claim 1 further comprising:
a switching element;
a housing defining a cylindrical interior space;
said lip seal being held in said cylindrical interior space; and,
said switching element being configured to be moved in an axial direction in said cylindrical interior space.

14. The fluid valve of claim 13, wherein, when the passage cross section is closed, said sealing lip divides said cylindrical interior space into an outlet volume connected to said pressure outlet and an inlet volume connected to said pressure inlet.

15. The fluid valve of claim 14, wherein a relief volume connected to a relief outlet is formed between said lip seal and said switching element; and, said relief volume and said outlet volume are connected to one another via a flow channel in said switching element, at least in a blocking position of said sealing lip.

16. The fluid valve of claim 15, wherein a connection from the relief volume to said flow channel is closed by a seal between said lip seal and said switching element in a passage position of said sealing lip.

17. The fluid valve of claim 1 further comprising:
a housing;
a switching element; and,
a control piston configured to be moved in said housing between an initial position and an actuating position, to be moved out of said initial position by pressure at a control port and, in the actuating position, to act on said switching element to actuate said sealing lip.

18. The fluid valve of claim 17, wherein said control piston separates a control volume, which is connected to said control port, from an outlet volume, which is connected to the pressure outlet.

19. The fluid valve of claim 1, wherein the fluid valve has at least two switching positions including a blocking position and a passage position; the fluid valve has at least four ports including said pressure inlet, said pressure outlet, a relief outlet and a control port; the fluid valve further comprising a housing and a switching element configured to be moved in said housing for selectively opening or closing the passage cross section from said pressure inlet to said pressure outlet in dependence upon a pressure at said pressure outlet and a pressure at said control port; and, the fluid valve further having a holding function of said switching element, such that the passage cross section is open when there is a pressure at said control port that is above a first limit value, and remains open even when the pressure at said control port falls below the first limit value again but, at the same time, there is a pressure above a second limit value at said pressure outlet.

20. A pneumatic valve arrangement comprising:
a park release valve;
a fluid valve including a pressure inlet and a pressure outlet; and,
said fluid valve further including a lip seal having a sealing lip between said pressure inlet and said pressure outlet, wherein said sealing lip has a position which is variable so as to vary a passage cross section.

21. The pneumatic valve arrangement of claim 20 further comprising:
a supply port;
a control port;
said fluid valve having a fluid valve control port;
said park release valve having a port;
said pressure inlet of said fluid valve being connected to said supply port, which is at a supply pressure, of the pneumatic valve arrangement;
said pressure outlet of said fluid valve being connected to said port of said park release valve; and,
said control port of said fluid valve being connected to said control port of the valve arrangement.

22. A pneumatic braking system for a vehicle comprising:
a fluid valve or a valve arrangement including said fluid valve and a park release valve;
said fluid valve including a pressure inlet and a pressure outlet; and,
said fluid valve further including a lip seal having a sealing lip between said pressure inlet and said pressure outlet, wherein said sealing lip has a position which is variable so as to vary a passage cross section.

23. The pneumatic braking system of claim 22, wherein the vehicle is a trailer vehicle.
